(19) United States
(12) Patent Application Publication
(10) Pub. No.: US 2014/0103020 A1
(43) Pub. Date: Apr. 17, 2014

(54) ELECTRIC CIGARETTE LIGHTER AND CHARGER THEREFOR

(71) Applicant: QASEM A. AL-QAFFAS, ALSALAM (KW)

(72) Inventor: QASEM A. AL-QAFFAS, ALSALAM (KW)

(21) Appl. No.: 13/649,971

(22) Filed: Oct. 11, 2012

(51) Int. Cl. H05B 3/00

(52) U.S. Cl. 219/201

(57) ABSTRACT

The electric cigarette lighter is a cigarette lighter that is dimensioned and configured to simulate a cigarette, thus allowing the cigarette lighter to be easily carried within a conventional pack of cigarettes. The electric cigarette lighter includes a cylindrical housing having opposed upper and lower ends, and an electric heating element mounted on the upper end thereof. At least one rechargeable battery is disposed within the cylindrical housing. The at least one rechargeable battery is in electrical communication with the electric heating element for selective operation thereof. A first indicator light is mounted on the sidewall of the cylindrical housing for visually indicating remaining charge of the at least one to rechargeable battery. A charging socket is mounted in the lower end of the cylindrical housing for electrical connection to an external battery charger. The charging socket is in electrical communication with the at least one rechargeable battery.

### BACKGROUND OF THE INVENTION

1. Field of the Invention

The present invention relates to cigarette lighters, and particularly to an electric cigarette lighter using a rechargeable battery and a charger therefor.

2. Description of the Related Art

Cigarette lighters typically use a combustible lighter fluid, which is ignited to create a flame. Due to the need to refill such lighters with lighter fluid, cheap disposable cigarette lighters are common. However, many users prefer decorative or personalized lighters, thus preventing them from using disposable lighters and requiring the constant refilling of the lighter with lighter fuel. It is thus desirable to provide an electric lighter utilizing an electrically powered heating element, thus removing the need to refill the lighter with a liquid fuel.

Even with personalized lighters, though, users often lose their lighters. Most smokers smoke throughout the day. Thus, they transport both their cigarettes and their cigarette lighter. Traveling with the lighter provides many daily opportunities for accidental loss of the lighter. Thus, it would be desirable to provide a cigarette lighter that easily and conveniently fits into a cigarette pack with the smoker's cigarette supply.

Thus, an electric cigarette lighter solving the aforementioned problems is desired.

### SUMMARY OF THE INVENTION

The electric cigarette lighter is a cigarette lighter dimensioned and configured to simulate a cigarette, thus allowing the cigarette lighter to be easily carried within a conventional pack of cigarettes. The electric cigarette lighter includes a cylindrical housing having opposed upper and lower ends. An electric heating element is mounted on the upper end. At least one rechargeable battery is disposed within the cylindrical housing, and the at least one rechargeable battery is in electrical communication with the electric heating element for selective operation thereof.

A first indicator light is mounted on the sidewall of the cylindrical housing for visually indicating remaining charge of the at least one rechargeable battery. A charging socket is mounted in the lower end of the cylindrical housing for electrical connection to an external battery charger. The charging socket is in electrical communication with the at least one rechargeable battery. Preferably, a second indicator light is also mounted on the sidewall of the cylindrical housing for visually indicating the charging status of the at least one rechargeable battery when the charging socket is engaged by the external battery charger.

These and other features of the present invention will become readily apparent upon further review of the following specification and drawings.

### BRIEF DESCRIPTION OF THE DRAWINGS

FIG. 1 is an environmental, perspective view of an electric cigarette lighter according to the present invention.

FIG. 2 is a perspective view of the electric cigarette lighter of FIG. 1 and a charger therefor.

FIG. 3 is a block diagram of the electrical components of an electric cigarette lighter according to the present invention.

Similar reference characters denote corresponding features consistently throughout the attached drawings.

### DETAILED DESCRIPTION OF THE PREFERRED EMBODIMENTS

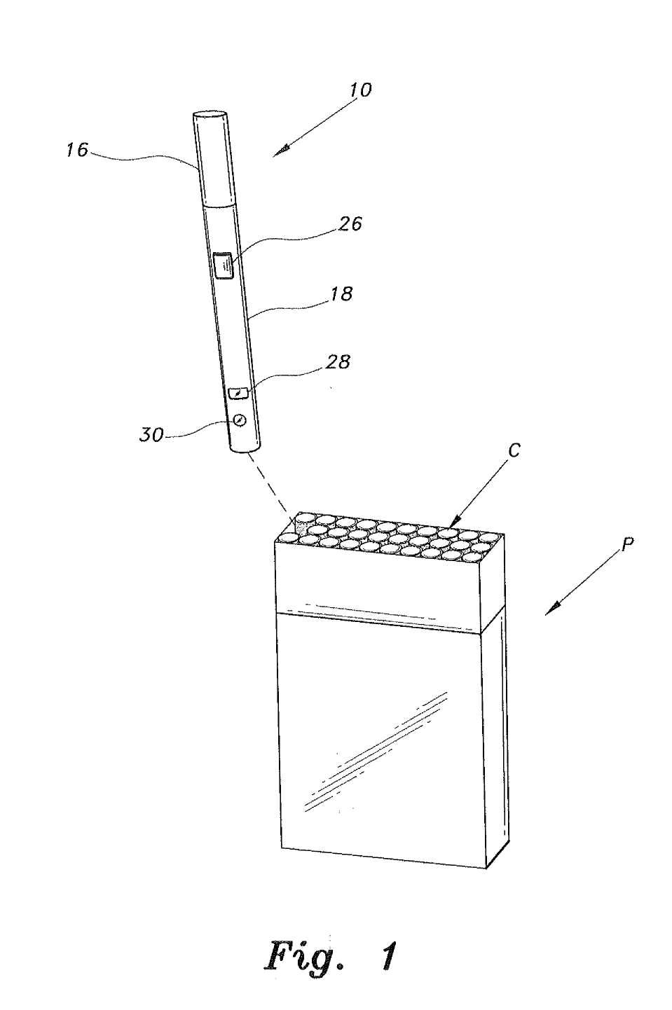

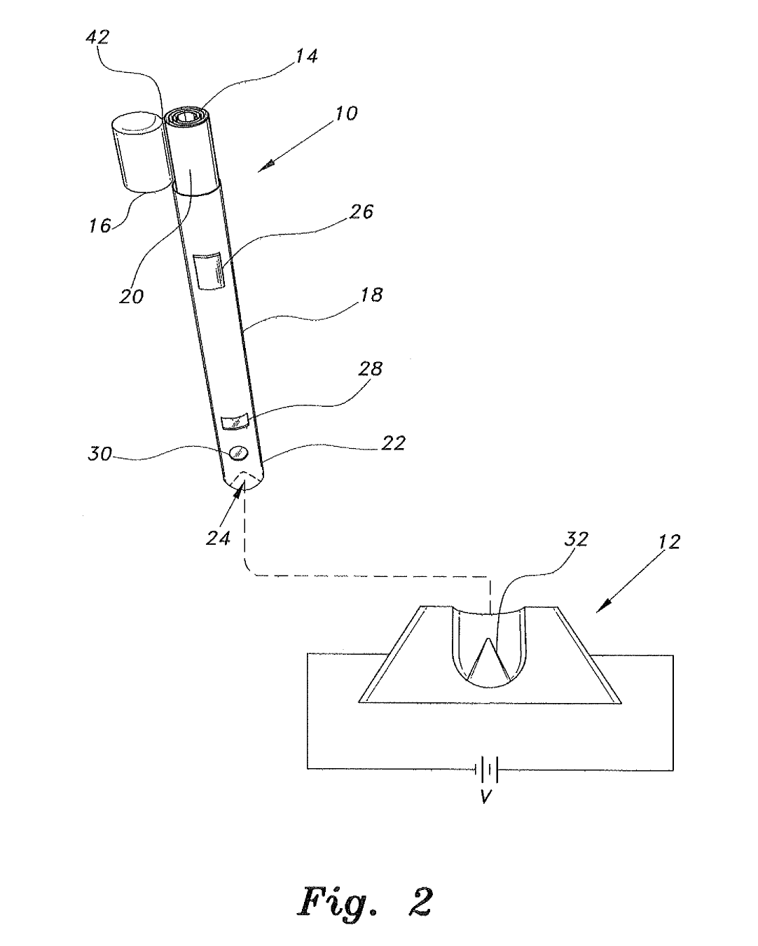

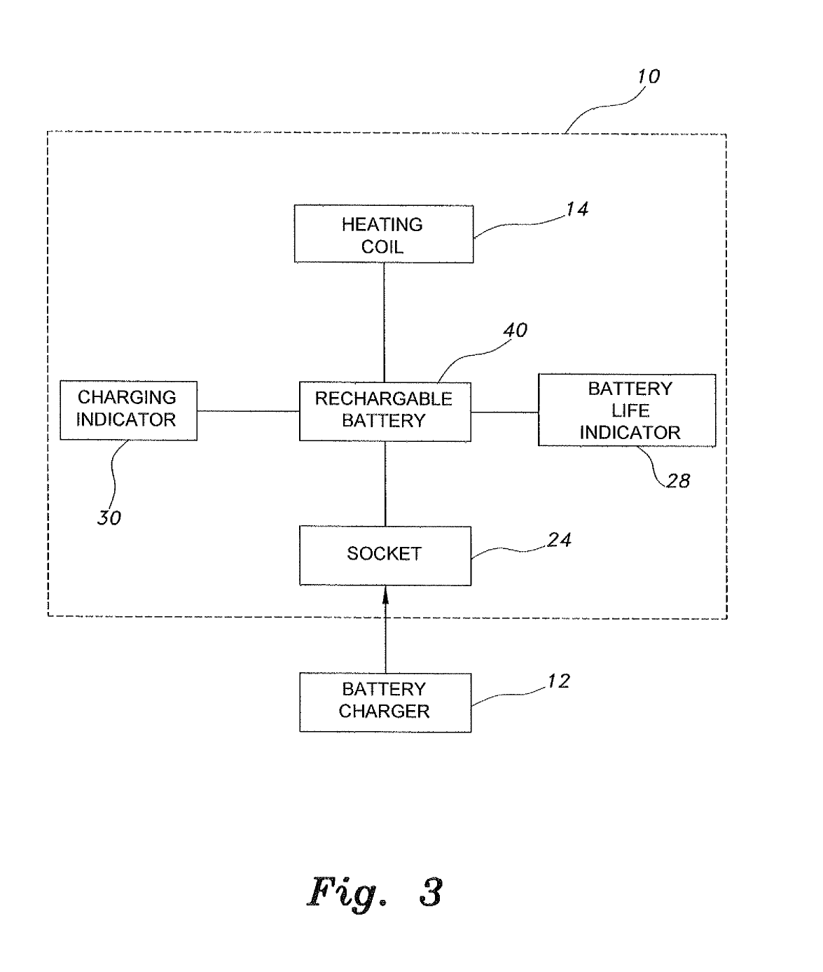

As shown in FIG. 1, the electric cigarette lighter 10 is a cigarette lighter that is dimensioned and configured to simulate a cigarette C, thus allowing the cigarette lighter 10 to be easily carried within a conventional pack of cigarettes P. As shown in FIGS. 2 and 3, the electric cigarette lighter 10 includes a cylindrical housing 18 having opposed upper and lower ends, 20, 22, respectively, and an electric heating element 14 mounted on the upper end 20. At least one rechargeable battery 40 is disposed within the cylindrical housing 18. The at least one rechargeable battery 40 is in electrical communication with the electric heating element 14 for selective operation thereof. A switch 26, which may be any suitable type of switch, is preferably mounted on a sidewall of the housing 18 for selective actuation of the heating element 14. It should be understood that at any suitable type of rechargeable battery and any suitable type of electrical heating element may be utilized. Examples of electric lighters utilizing such electrical heating elements are shown in U.S. Pat. Nos. 2,991,875 and 3,419,704, each of which is hereby incorporated by reference in its entirety.

A first indicator light 28 is mounted on the sidewall of the cylindrical housing 18 for visually indicating remaining charge of the at least one rechargeable battery 40. A charging socket 24 is mounted in the lower end 22 of the cylindrical housing 18 for electrical connection to the contacts 32 of an external battery charger 12. The charging socket 24 is in electrical communication with the at least one rechargeable battery 40, It should be understood that the cigarette lighter 10 and the external battery charger 12 may be sold together in a kit, or may be provided separately. It should be further understood that the battery charger 12 may be any suitable type of battery charger. Battery chargers for rechargeable batteries are known in the art, and any suitable type of charger along with any suitable type of socket-type connection may be utilized, The battery charger 12 may be powered by any suitable external electrical power supply V, such as a conventional wall socket or the like.

Preferably, a second indicator light 30 is also mounted on the sidewall of the cylindrical housing 18 for visually indicating the charging status of the at least one rechargeable battery 40 when the charging socket 24 is engaged by the external battery charger 12. The indicator lights 28, 30 may be light emitting diodes (LEDs). In use, when the first light 28 indicates that the charge is running low, the user connects the cigarette lighter 10 to battery charger 12 via the socket 24 to recharge the at least one rechargeable battery 40. The second light 30 indicates charging status, For example, while charging, the second light may flash a red light, and when fully charged, the second light 30 may provide a steady green light to indicate full charging. The lighter 10 may then be removed from battery charger 12 for direct use, or for storage within a cigarette pack P.

Additionally, a cap 16 may be provided for covering the heating coil 14 mounted on the upper end 20 of the cylindrical housing 18. Preferably, to prevent accidental loss of the cap 16, the cap 16 is pivotally secured to upper end 20 by a hinge 42 or the like.

It is to be understood that the present invention is not limited to the embodiments described above, but encompasses any and all embodiments within the scope of the following claims.

1. An electric cigarette lighter, consisting of:
an elongate cylindrical housing having opposed upper and lower ends, the housing being dimensioned and configured to simulate a cigarette, wherein the diameter of the housing is approximately one-quarter inches;
an electric heating element mounted on the upper end of the cylindrical housing;
at least one rechargeable battery disposed within the cylindrical housing, the at least one rechargeable battery being in electrical communication with the electric heating element for selective operation thereof;
a single indicator light for visually indicating remaining electrical charge of the at least one rechargeable battery;
a single indicator light for visually indicating a charging status of the at least one rechargeable battery;
a charging socket mounted in the lower end of the cylindrical housing, the socket being adapted for electrical connection to an external battery charger, the charging socket being in electrical communication with the at least one rechargeable battery; and
a cap releasably covering the electric heating element, wherein the cap is hingedly secured to the upper end of the cylindrical housing.

2-6. (canceled)

7. An electric cigarette lighter, consisting of:
an elongate cylindrical housing having opposed upper and lower ends, the housing being dimensioned and configured to simulate a cigarette, wherein the diameter of the housing is approximately one-quarter inches;
an electric heating element mounted on the upper end of the cylindrical housing;
a cap releasably covering the electric heating element;
a hinge for pivotally securing the cap to a sidewall of said cylindrical housing adjacent the upper end thereof;
at least one rechargeable battery disposed within the housing, the at least one rechargeable battery being in electrical communication with the electric heating element for selective operation thereof;
a charging socket mounted in the lower end of the cylindrical housing, the socket being adapted for electrical connection to an external battery charger, the charging socket being in electrical communication with the at least one rechargeable battery;
a single indicator light mounted on a sidewall of said cylindrical housing for visually indicating the remaining charge of the at least one rechargeable battery; and
a single indicator light mounted on the sidewall of said cylindrical housing for visually indicating charging status of the at least one rechargeable battery when said charging socket is engaged by the external battery charger.

8-12. (canceled)

13. An electric cigarette lighter and charger kit, consisting of:
an elongate cylindrical housing having opposed upper and lower ends, the housing being dimensioned and configured to simulate a cigarette, wherein the diameter of the housing is approximately one-quarter inches;
an electric heating element mounted on the upper end of the cylindrical housing;
a cap releasably covering the electric heating element and pivotally secured to a sidewall of said cylindrical housing, adjacent the upper end thereof;
at least one rechargeable battery disposed within the cylindrical housing, the at least one rechargeable battery being in electrical communication with the electric heating element for selective operation thereof;
a single indicator light for visually indicating remaining charge of the at least one rechargeable battery;
a single indicator light for visually indicating a charging status of the at least one rechargeable battery;
a battery charger; and
a charging socket mounted in the lower end of the cylindrical housing for electrical connection to the battery charger, the charging socket being in electrical communication with the at least one rechargeable battery;
wherein said single indicator light visually indicating charging status of the at least one rechargeable battery indicates when said charging socket is engaged by the external battery charger.

14-18. (canceled)
